(19) United States
(12) Patent Application Publication
(10) Pub. No.: US 2012/0215533 A1
(43) Pub. Date: Aug. 23, 2012

(54) Method of and System for Error Correction in Multiple Input Modality Search Engines

(75) Inventors: Murali Aravamudan, Windham, NH (US); Pankaj Garg, Patiala (IN); Rakesh Barve, Bangalore (IN); Ajit Rajasekharan, West Windsor, NJ (US)

(73) Assignee: Veveo, Inc., Andover, MA (US)

(21) Appl. No.: 13/357,982

(22) Filed: Jan. 25, 2012

Related U.S. Application Data
(60) Provisional application No. 61/436,442, filed on Jan. 26, 2011.

(51) Int. Cl. G10L 15/26; G06F 17/30

(52) U.S. Cl. 704/235; 707/706; 707/E17.108; 704/E15.043

(57) ABSTRACT

A method of and system for error correction in multiple input modality search engines is presented. A method of processing input information based on an information type of the input information includes receiving input information for performing a search for identifying at least one item desired by a user and determining an information type associated with the input information. The method also includes forming a query input for identifying the at least one item desired by the user based on the input information and on the information type. The method further includes submitting the query input to at least one search engine system.

### CROSS-REFERENCE TO RELATED APPLICATIONS

This application claims the benefit under 35 U.S.C. §119(e) to U.S. Provisional Patent Application No. 61/436,442, entitled Method of and System for Error Correction in Multiple Input Modality Search Engines, filed on Jan. 26, 2011, the contents of which are incorporated by reference herein.

### BACKGROUND OF THE INVENTION

1. Field of Invention

The invention generally relates to correcting user input errors based at least in part on the source type of the input, and, more specifically, to techniques for adapting error correction methods by taking into account the unique error properties common in the original input mechanism and in the translation, when needed, of the input to the final presentation form.

2. Description of Related Art

Search engines on mobile phones (FIG. 5) are expanding the input modality from keypad based text to include speech and/or image/video. While pure speech based search and pure image based search engines are emerging, most popular ones transform the input of the new modalities to text either in-part or fully. For instance, speech is used as an alternative to input text instead of the keypad, and Optical Character Recognition (OCR) scan of images are used to populate the traditional text input box of text input based search. It has been discovered by the Applicants that, in these scenarios, just as there could be typographic or orthographic errors in text input, other forms of errors characteristic to the transformation of the input modality (e.g. speech to text) or extraction of text from the input modality (e.g., image OCR scan for text), make the challenge of understanding user intent even more difficult.

It was further discovered by Applicants that the problem is further complicated by the fact that the nature and characteristics of these errors are not the same across these different modalities, making an error correction model specific to any particular input modality ineffective. Furthermore, most of the multiple modality search engines also permit the user to edit and augment the text that was either transformed or extracted from other input modalities. This further exacerbates the problem of using an error correction model tailored to a specific input type.

### BRIEF SUMMARY OF THE INVENTION

Under one aspect of the invention, a method of and system for error correction in multiple input modality search engines is disclosed.

Under another aspect of the invention, a method of processing input information based on an information type of the input information includes receiving input information for performing a search for identifying at least one item desired by a user and determining an information type associated with the input information. The method also includes forming a query input for identifying the at least one item desired by the user based on the input information and on the information type and submitting the query input to at least one search engine system.

Under a further aspect of the invention, the method also includes determining a ranking order for items identified by the at least one search engine system. The ranking order is based at least in part on the information type.

Under yet another aspect of the invention, the forming the query input comprises correcting at least one of orthographic and typographic errors present in the input information when the information type is text input.

Under still a further aspect of the invention, the forming the query input comprises matching at least one term present in the input information with at least one search concept when the information type is text input.

Under another aspect of the invention, the matching at least one term comprises substituting in the query input at least one unambiguous search concept in place of the at least one term when the at least one term comprises ambiguous text input.

Under still another aspect of the invention, the information type is text input, the input information includes at least two terms, and the forming a query input includes forming a first query in which the at least two terms are joined by a conjunction operator and forming a second query in which the at least two terms are joined by a disjunction operator. The method also includes determining a ranking order for items identified by the at least one search engine system. The determining the ranking order includes ranking results corresponding to the first query more highly than results corresponding to the second query.

Under a further aspect of the invention, the information type is image input and the input information includes an image. The forming the query input includes generating text from at least a portion of the image.

Under still a further aspect of the invention, the forming the query input further include substituting at least one character placeholder in the generated text in place of a portion of the image that was not successfully generated as text.

Under another aspect of the invention, the forming the query input includes matching at least one term present in the generated text with at least one search concept when the information type is image input.

Under yet another aspect of the invention, the generated text including at least two terms and forming a query input includes forming a first query in which the at least two terms are joined by a conjunction operator and forming a second query in which the at least two terms are joined by a disjunction operator. The method also includes determining a ranking order for items identified by the at least one search engine system. The determining the ranking order includes ranking results corresponding to the second query more highly than results corresponding to the first query.

Under still another aspect of the invention, the information type is audio input and the input information includes a spoken phrase. The forming the query input includes generating text from at least a portion of the spoken phrase.

Under a further aspect of the invention, the forming the query input also includes correcting phonetic recognition errors introduced in the generated text.

Under yet another aspect of the invention, the forming the query input includes matching at least one term present in the generated text with at least one search concept when the information type is audio input.

Under a further aspect of the invention, the generated text includes at least two terms, and forming a query input includes forming a first query in which the at least two terms are joined by a conjunction operator and forming a second query in which the at least two terms are joined by a disjunction operator. The method also includes determining a ranking order for items identified by the at least one search engine system. The determining the ranking order includes ranking results corresponding to the second query more highly than results corresponding to the first query.

Other aspects of the invention include systems for performing any of the above recited techniques.

Any of the above aspects can be combined with any of the other aspects recited above.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 illustrates the various input modalities and the common types of errors occurring with the input modality.

FIG. 2 illustrates the flow of input to the search engine and the transformation/extraction steps of speech and image input to text.

FIG. 3 illustrates a list of terms from all three input modalities and the different error correction and results generation rules based on the input source type.

FIG. 4 illustrates an instance of results not matching users intent, when the input source is not factored in for error correction.

FIG. 5 illustrates a search input including speech and/or video input modes.

### DETAILED DESCRIPTION OF THE PREFERRED EMBODIMENTS

Embodiments of the invention general relate to correcting errors present in user input to user interface systems based at least in part on the source type of the input (or, as also described herein, on the type of modality of the input or information type associated with the input). Some implementations also apply particular techniques to error correction when transforming the original input mode (e.g., speech input) to the final presentation mode (e.g., text input).

As mentioned above, input modalities to user interfaces have expanded beyond the traditional text input mode. The expansion of input modalities available for search engines poses an even greater challenge that goes beyond just correcting for errors in input across these different input modalities. The nature of the input modality, and the potential errors that come with it, also have a bearing on the expectation of results from a user perspective. For example, the standard input mechanism for text input in most search engines doesn't require the user to explicitly specify the conjunction or disjunction (e.g. term1 and term2 or term3) between terms of input. Thus, a user may just type “meryl streep clint eastwood”. In response, the system automatically performs a conjunction operation to identify results that contain all search terms as metadata associated with the item. For example, because Meryl Streep and Clint Eastwood were both actors in the movie “The Bridges of Madison County”, a link to the movie and/or documents/webpages about the movie would be returned.

Furthermore, in text input search, particularly in incremental search systems, the user may partially type terms, and the system devises the likely user-intended combinations of terms to make phrases and performs the intended conjunctions and disjunctions to produce the results set. These assumptions made for text input search (be it incremental or non-incremental) do not apply across input source types. For instance, when the user types two words explicitly on a mobile device, the intent in most cases is a result that is a conjunction of the concepts or terms, where the intent was to identify a result by a phrase (e.g., twist and shout) or a conjunction of concepts (e.g., “meryl eastwood” to find movies where Meryl Streep and Clint Eastwood acted together). In an incremental search system that accepts partial word inputs (e.g., “mery eastw”), where results are displayed as the user types the input, the expectation of the user when the “eastw” prefix is typed after the “meryl” prefix was typed is to get conjunction results with both actors (note here that the user drops the first or last names of the persons and does not complete the terms entered). Offering results that are a disjunction of terms in this example “meryl eastwood”, would most likely not match the user's expectation.

In contrast, in the case of speech input (or, more generally, audio input), “twist and shout” could be translated, with errors in speech to text processing, to “piston shout” and a pure conjunction based approach would not bring the desired result. However a system that offers search results based on a disjunction of the two search terms—“piston or shout”—may still retrieve a result relevant to the search input “twist and shout” because of the match with term “shout”. Thus, for a speech input mode, the use of an implied disjunction between terms may be desirable. In contrast, a text input mode would not suffer the input error which caused “twist and” to be processed as “piston”. Therefore, it would be undesirable if the results offered for a phrase match for text input “twist and shout” included results based only on “shout” as a result of processing an implied disjunction between the main terms “twist” and “shout”.

Thus, embodiments of the invention take into account the influence of the input method on the processing (and error correction) of input such as, but not limited to, (1) the terms, e.g., whether they are partial terms or an incomplete variant (prefix, infix, and/or suffix), (2) the level of affinity between adjacent terms to compile aggregated terms, and/or (3) classification of the aggregated terms as concepts or phrases, to decide the best way to order disjunction and conjunction results, so as to increase the chance of matching user's intent. Embodiments of the invention, thus, make error correction a part of the input processing sequence that takes into account the input source type to decide the best method to process the input for errors and the for the generation of results.

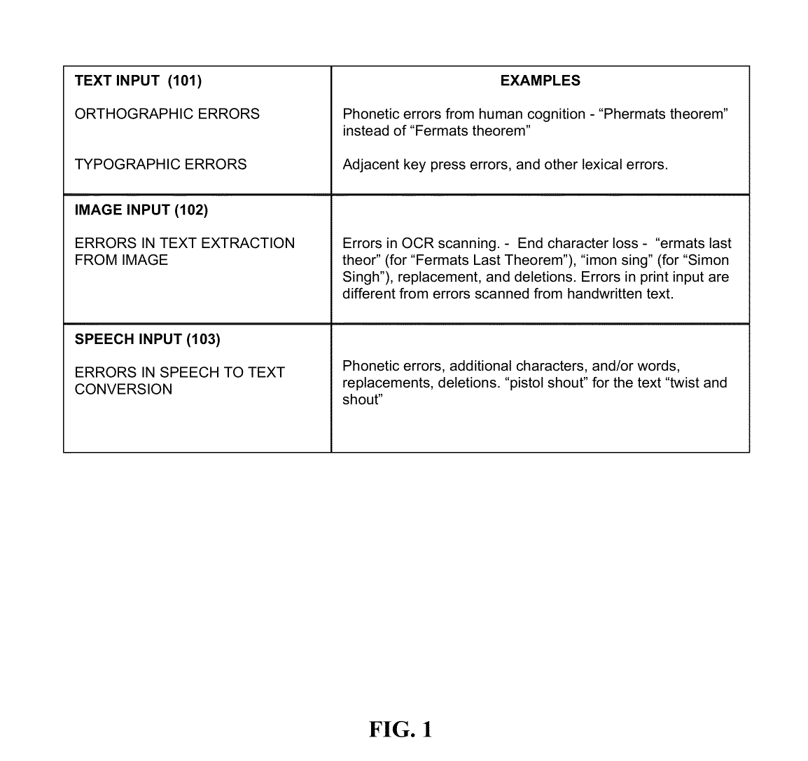

FIG. 1, illustrates the errors commonly present in different input modalities, including examples. Text input 101 errors can be broadly classified into orthographic errors and typographic errors. Examples of orthographic errors are phonetic errors such as “Phermats Last theorem” instead of “Fermat's Last theorem”. Typographic errors are errors from misspellings of errors, partly from pressing wrong keys on the keypad, or missing the entering of a letter, etc. Determining the terms of input that are text input terms would help in correcting for the orthographic and typographic errors in input.

Image input 102 is scanned for text and the extracted text could be used as input to text search engine. Any of the techniques for converting images to text known in the art (e.g., Optical Character Recognition) can be used to generate the text input. In this case, the errors that are present are Optical Character Recognition (OCR) errors, such as loss of characters, particularly in the boundaries of the scan region, result in characters being lost in the beginning and ending of phrases/terms. Furthermore, the nature of errors in OCR could also depend on scanning handwritten text or print text. Knowledge of this could further assist the text search engine for error correction and results generation as will be described down below. Speech input 103 can be converted to text and the errors in conversion are very similar to the phonetic errors of text input. However, unlike text input, speech to text conversion could cause multiple distinct terms to be coalesced into a single phrase as in “twist and shout” being interpreted as “pistol shout”.

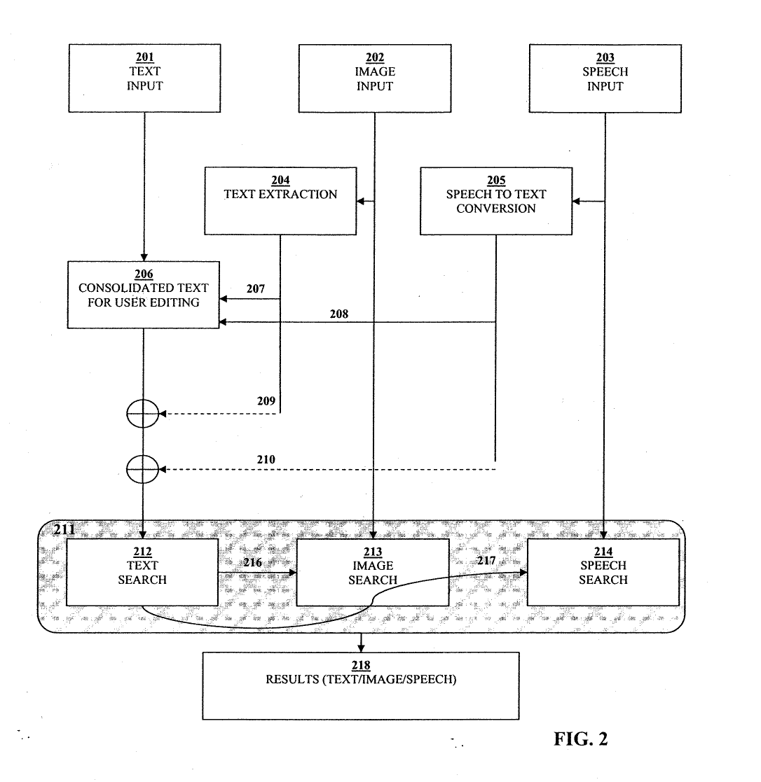

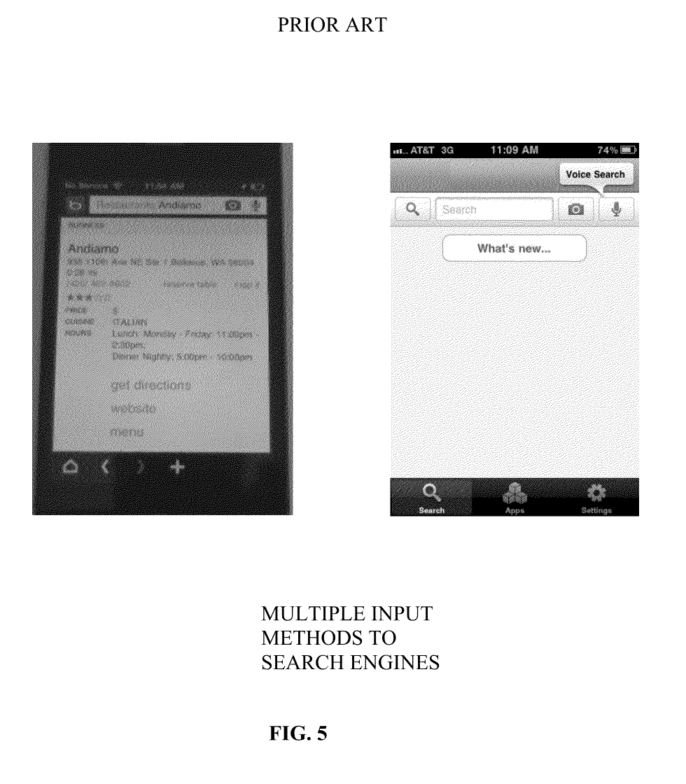

FIG. 2 illustrates the flow of input to the search engine and the transformation/extraction steps of speech and image input to text (such as could be provided by a multi-mode input interface, e.g., as in FIG. 5). The text input 201 by the user, in a text box interface, could be fed to the search engine system 211. The search engine system 211 could reside on a mobile device fully and/or reside fully or partially remotely on the network. In certain implementations, the terms input as text 201 are tagged as “text input source” to enable the text search engine 212 of the search engine system 211, to be aware of the nature of the input source type.

Image/video input 202, captured on device by the mobile device camera could be scanned for text by a text extraction module 204. Text extraction module 204 can either reside locally on the device or it could be resident on a remote service. In an embodiment of the invention, the extracted text is sent to text input interface (at 207) and, optionally, consolidated with other text input forms 206. This consolidation of text from multiple modalities 206, enables the user to edit the terms before feeding it to text search 212. In some implementations, the text extraction module 204 tags the extracted text with the source type, e.g., “image source” to make the text search engine 212 aware of the input source type in order to perform selected error correction methods. In another embodiment of the invention, the extracted text 204 is directly fed 209 to the text search engine 212 without consolidating the text from the input modalities 206. The text source type for the extracted text 204 is tagged as “image source” in this path also. The input image 202 can also be fed directly to the image search engine 213 component of the search engine system 211.

Speech input 203, e.g., captured on the mobile device using a microphone, can be directly fed to speech search engine 214 and/or also can be sent to the speech to text conversion module 205. This module could be resident locally on device or remotely on a server and can implement any of the speech-to-text conversion techniques known in the art. The converted text is fed (at 208) to the text consolidation interface 206 or is directly fed 210 to the text search engine 212. In either case, in certain implementations, the terms of converted text are explicitly tagged as, e.g., “speech source”.

In an embodiment of the invention where text from the different modalities is consolidated for user editing 206, the editing process preserves the input source information for terms that are not edited. For terms that are edited, the source tagging still preserves the original source type in addition to the fact that the term was edited. The results of text search, after error correction has been performed on the input source tagged terms, could be used, in an embodiment of the invention, for assisting (at 216 and 217) the image search 213 and speech search 214. The results of the search engine system 211, could be a combination of the individual search techniques (e.g., text, image, and/or speech) 218.

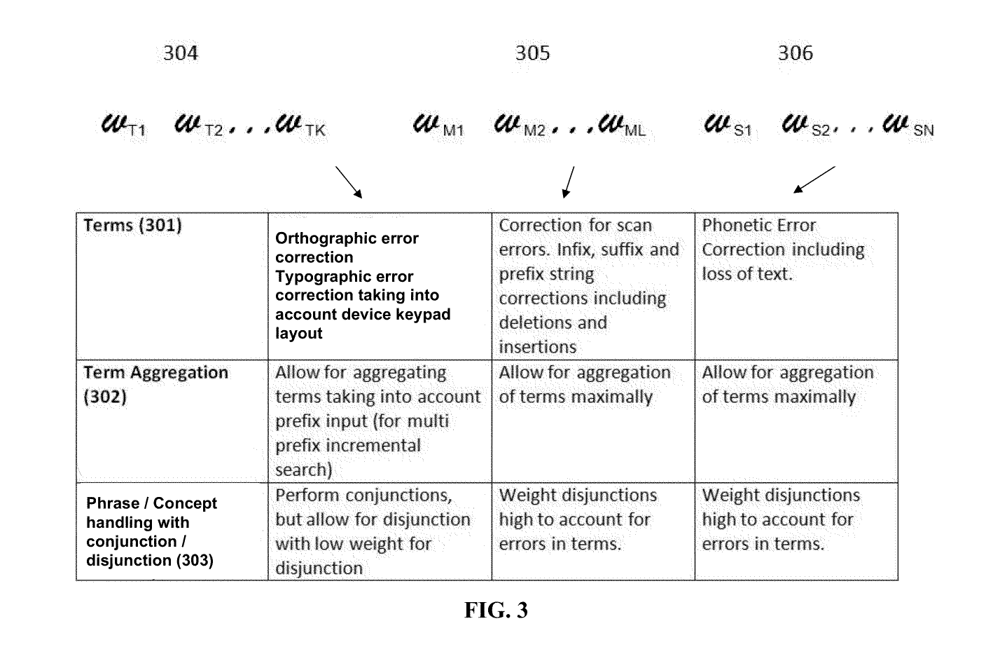

FIG. 3 illustrates input source type tagged terms 304, 305, and 306, from all three source types—text, image, and speech, respectively. While the example illustrates input from all sources, in some usages cases, only one or more of the input sources may be present. However, all of them can be present. The table illustrates the handling of terms 301, the aggregation of terms to phrases 302, and the criterion to apply disjunction or conjunction to results 303. These steps are not meant to be exhaustive but, rather, representative of the various types of error correction and results generation processing that are influenced by the input source type tag.

In an illustrative embodiment, the terms 301 error correction method applied to text input 304, particularly for incremental text, is described in U.S. Pat. No. 7,644,054, entitled System and Method for Finding Desired Results by Incremental Search Using an Ambiguous Keypad with the Input Containing Orthographic and Typographic Errors”, issued Jan. 5, 2010, incorporated by reference herein. That patent described techniques for replacing characters in a user-input text search string based on the layout of the keys of the input device and/or replacing characters of the search string based on phonetic substitutions.

Meanwhile, in certain implementations, the terms 301 error correction method applied to image input 305, e.g., for text resulting from an OCR operation on a picture of text, includes substituting characters and/or wildcard operators (character placeholders) in certain places in the text string resulting from the OCR operation. For example, a one or more character wildcard operator or a single character wildcard operator can be placed at the beginning of the first word in a string of identified words and/or on the end of the last word to represent characters that may not have been captured in the image. In one implementation, a set of searches are performed using a wildcard operator representing a single missing character at the beginning of the first word, followed by a wildcard operator representing two missing characters at the beginning of the first word, and so on, until a predetermined number of wildcard operators is reached or until a result set contains a suitable number of result items.

For example, assume an image of the title of a book “Fermat's Last Theorem” is captured by the user and submitted as input for a search. However, the user accidentally truncated the first three characters such that the OCR process result of the image is “mat's Last Theorem”. An embodiment of the invention would first submit “[]mat's Last Theorem” (where the set of brackets equals any single character), followed by “[][]mat's Last Theorem”, followed by “[][][]mat's Last Theorem”, and so on until a set number of single character wildcard operators had been applied or until a suitable number of results is found. Similarly, wildcard operators can be appended to the end of the last word of the OCR process result alone or in combination with the wildcard operators appended to the beginning of the first word. In an alternate process, a one or more character wildcard operator can be used in place of a fixed number of single character wildcard operators.

In addition, a one or more character wildcard operator or a single character wildcard operator can be placed in any word in a position that corresponds to the location of a character or set of characters that was not properly resolved during the OCR process. In such a case, the OCR process identifies the location in a string of characters for which the process was not able to find a suitable character match. Based on the determined character size, the error correction method can determine the suitable number of wildcard characters to place at the desired location. For example, assume an image of the title of a book “Fermat's Last Theorem” is captured by the user and submitted as input for a search. However, a portion of the title was unreadable by the OCR process, such that the “eo” character in the middle of the work “Theorem” are not properly resolved, resulting in a search string “Fermat's Last Th_rem”.

Although the OCR process was not able to resolve the “e” and the “o” characters, based on the size of the characters in the rest of the string, the OCR process approximates that two characters would fit in the space of the unresolved input. In one implementation of the invention, the search system 211 inputs two single character wildcard operators in place of the missing characters to form the search string “Fermat's Last Th[][]rem”. In an alternate process, a one or more character wildcard operator can be used in place of the two single character wildcard operators.

Meanwhile, in certain implementations, the terms 301 error correction method applied to speech-to-text input 306 includes phonetic error correction techniques, including, but not limited to, changing one or more words of the text string resulting from the speech-to-text process. For example, a set of rules governing common phonetic recognition errors can be applied to the input, based upon the input being tagged as speech input, to correct common errors. For example, it may be known based on statistical analyses performed on speech recognition performance that certain single words output by a speech-to-text process (such as recognition systems based on Hidden Markov Models or other known techniques) were, in fact, two distinct words spoken by the user that were erroneously recognized as the single word. In such a case, the search system 211 replaces the commonly mistaken single word with the two words associated with the mistaken recognition. For example, as described above, if it is known that the phrase “twist and” is often recognized as “pistol”, a substitution for the correct words can be made at the time of processing the search input. Likewise, certain portions of spoken words can be dropped or lost. In these cases, the error correction techniques can substitute a word that most closely matches the portion of the spoken word that was recognized.

In addition to terms corrections, different term aggregation techniques 302 can be applied based on the source type. Term aggregation describes a technique for deriving a concept from more than one search term. Thus, rather than processing certain terms using a conjunction or disjunction operation, a unique meaning associated with the terms is submitted to the query processing engine. The concept, or metadata associated therewith, can then be used in the search query. For example, the two separate search terms “meryl” and “streep” are aggregated into the concept Meryl Streep, the actress. Likewise, the set of terms “clint” and “eastwood” can be aggregated into the concept Clint Eastwood, the actor. Thus, rather than simply applying a conjunction operation on the four search terms “meryl streep clint eastwood”, the aggregation process creates a query involving two unique concepts Meryl Streep and Clint Eastwood. A conjunction or disjunction can be applied to the two concepts, as described below. In addition, independent searches can be performed on each concept, and then the individual results from each can be intersected to provide the final search results.

Aggregating multiple terms into a concept can help a user to find desired results when a conjunction operation fails to capture the user's intent. This is so because, unlike the example given above (where the terms “meryl streep” directly correspond to the concept of Meryl Streep the actress), the user may use a set of terms to indirectly represent a concept. For example, the user may not recall the name of the actress Meryl Streep nor the name of the movie in which she co-starred with Clint Eastwood. However, the user does recall that the actress who's name he cannot recall stared as Margaret Thatcher in the movie “The Iron Lady”. Thus, the user can enter the input information “iron lady clint eastwood” in which “iron lady” indirectly identifies the actress who played Margaret Thatcher in the movie The Iron Lady.

The aggregation techniques disclosed herein would then create two concepts—“iron lady” and “clint eastwood”—for submission to a search engine system. In this example, the concept The Iron Lady has various metadata associated with it, including Meryl Streep as the lead actress in the movie. Thus, a search query employing the metadata associated with the concept The Iron Lady would return Meryl Streep as well as the movies in which she has starred. Meanwhile, a search performed on the concept Clint Eastwood would also return the movies in which he has starred. Upon intersecting the two result sets, the movie “The Bridges of Madison County” would be highly ranked because both Meryl Streep and Clint Eastwood star in the movie. Moreover, because both The Iron Lady concept and Clint Eastwood concept have associated metadata that describes those concepts as related to “movies”, this metadata can further be used to filter the returned search results and/or establish a ranking order for the results that are returned to the user. In contrast, a conjunction operation on the four terms “iron lady clint eastwood” would not capture the user's intent and would fail to discover the desired movie.

In addition to multiple terms, the aggregation technique can be applied to a single term or set of characters. For example, a user may enter the initials of an actor to identify that actor as one of the search concepts. Thus, the user input information “tc” can be matched with the search concept “Tom Cruise”. Therefore, although the word “aggregate” typically means to form into a group or cluster a plurality of separate items, as used in connection with the aggregation techniques described herein, aggregate can also mean substituting one term or collection of letters for a search concept.

In order to determine which term or terms to aggregate into a search concept, the aggregation techniques compare the user's input information, such as individual abbreviations, partial words, or whole words, to a set of predetermined search concepts. If all or portions of the input information match or are sufficiently close to a known search concept, then the metadata associated with the search concept can be employed in the search query and/or ranking and ordering of the search results.

U.S. Pat. No. 7,536,384, entitled Methods and Systems for Dynamically Rearranging Search Results into Hierarchically Organized Concept Clusters, describes techniques for manipulating search results according to concept cluster with which they are associated. These techniques can be used in combination with the techniques disclosed herein for using metadata associated with the search concepts for organizing search results as well as using the metadata to conduct searches. Likewise, U.S. Pat. No. 7,788,266, entitled Method and System for Processing Ambiguous, Multiterm Search Queries, describes techniques for finding results based on ambiguous and/or partial word text input information. These techniques can be used in combination with the techniques disclosed herein for finding matches between the input and potential results as well as for finding search concepts that correspond to the input information.

In addition to the aggregation techniques 302, different phrase handling techniques 303 can be applied based on the source type. As mentioned above, for text input 304, the user typically intends a conjunction operation between all terms. Thus, when the source of input is text, results from a conjunction operation are more highly ranked in the search results. However, disjunction results (in which an “or” operation is applied to all terms) can, optionally, be presented, with these results receiving a lower ranking in the presentation order. In addition, the phrase handling techniques 303 can work in combination with the term aggregation techniques 302. Thus, after particular search terms have been aggregated into concepts, a disjunction operation can be applied to the concepts that were formed by joining one or more terms using the aggregation techniques 302. The results of such a search could be ranked the highest of all results or ranked between the results from the pure conjunction and the results from the pure disjunction, depending on the particular system configuration.

Meanwhile, when the source of the input is image input 305 and/or speech input 306, the search system 211, in some implementations, performs a disjunction operation to all terms in order to account for the presence of erroneously translated terms. Optionally, the search system can perform both a disjunction operation and a conjunction operation, while applying a higher rank to the results obtained by the disjunction operations. Moreover, the phrase handling techniques 303 can also work in combination with the aggregation techniques 302, as set forth in more detail above.

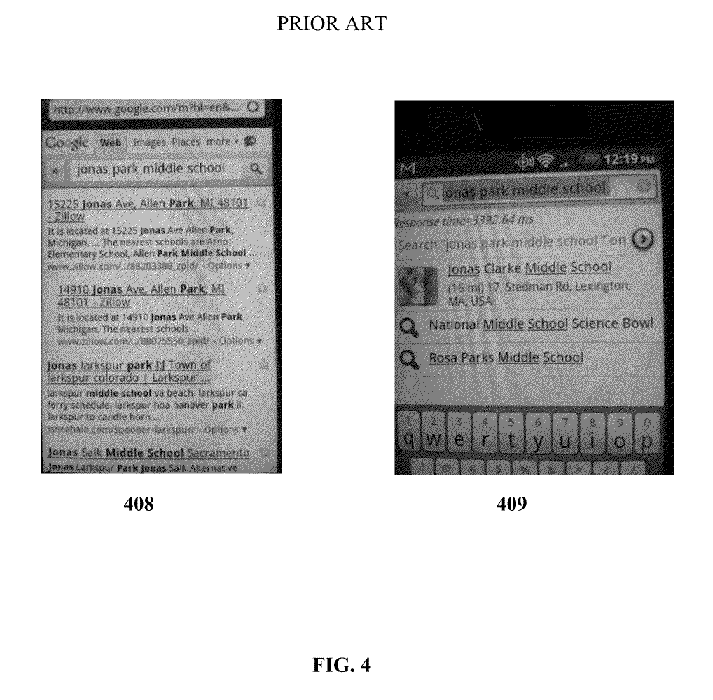

FIG. 4 illustrates an instance of results not matching users intent, when the input source is not factored in for error correction. In the prior art case 408, the speech to text conversion introduces an error—user's speech input “Jonas Clarke Middle School” gets converted into “Jonas Park Middle School”. The results do not match user intent, since the search results do not factor in the likely errors that could be introduced when the input source was speech. Specifically, the use of the default conjunction operator prevents the desired result from being included in the most highly ranked search results because the erroneously translated term “Park” was not present in the desired result.

In contrast, by applying implementations of the invention described herein, the search yields results that match user intent, a link about “Jonas Clark Middle School”, though the input was “Jonas Park Middle School” 409. In this example, the system tagged each of the translated search terms as coming from a speech source. Thus, the search engine system 211 applied a relatively higher weight to search results that came from a disjunction operation, which resulted in the desired link being ranked highly. Moreover, the search engine system 211 can take into account the fact that the desired link appeared as a result for three of the four search terms to more highly rank the desired result.

The types of items and/or content that can be returned as search results according to the techniques disclosed herein include any type of item. Non limiting examples include (1) media content, such as music, movies, television shows, web audio/video content, podcasts, picture, videos, and electronic books, (2) personal information items, such as electronic mail items, address book entries, electronic calendar items, and SMS and/or MMS message items, (3) computer system items, such as documents, applications, and server resources, and/or (4) Internet-based content, such as website links, items for sale, news articles, and any web-based content.

The techniques and systems disclosed herein may be implemented as a computer program product for use with a computer system or computerized electronic device (e.g., Smartphone, PDA, tablet computing device, etc.). Such implementations may include a series of computer instructions, or logic, fixed either on a tangible medium, such as a computer readable medium (e.g., a diskette, CD-ROM, ROM, flash memory or other memory or fixed disk) or transmittable to a computer system or a device, via a modem or other interface device, such as a communications adapter connected to a network over a medium.

The medium may be either a tangible medium (e.g., optical or analog communications lines) or a medium implemented with wireless techniques (e.g., Wi-Fi, cellular, microwave, infrared or other transmission techniques). The series of computer instructions embodies at least part of the functionality described herein with respect to the system. Those skilled in the art should appreciate that such computer instructions can be written in a number of programming languages for use with many computer architectures or operating systems.

Furthermore, such instructions may be stored in any tangible memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments may be implemented as a combination of both software (e.g., a computer program product) and hardware. Still other embodiments are implemented as entirely hardware, or entirely software (e.g., a computer program product).

Further still, any of the various process steps described herein that occur after the user has submitted the text, image, and/or speech input can be processed locally on the device and/or on a server system that is remote from the user device. For example, upon capturing an image, the digitized image can be transmitted to a remote server system for further processing consistent with the disclosure above. Optionally, or alternatively, the image can be processed locally on the device and/or compared to a locally resident database of information.

What is claimed is:

1. A method of processing input information based on an information type of the input information, the method comprising:
receiving input information for performing a search for identifying at least one item desired by a user;
determining an information type associated with the input information;
forming a query input for identifying the at least one item desired by the user based on the input information and on the information type; and
submitting the query input to at least one search engine system.

2. The method of claim 1, further comprising:
determining a ranking order for items identified by the at least one search engine system, the ranking order being based at least in part on the information type.

3. The method of claim 1, the forming the query input comprising correcting at least one of orthographic and typographic errors present in the input information when the information type is text input.

4. The method of claim 1, the forming the query input comprising matching at least one term present in the input information with at least one search concept when the information type is text input.

5. The method of claim 4, the matching at least one term comprising substituting in the query input at least one unambiguous search concept in place of the at least one term when the at least one term comprises ambiguous text input.

6. The method of claim 1, the information type being text input and the input information including at least two terms, wherein:
the forming a query input comprises:
forming a first query in which the at least two terms are joined by a conjunction operator; and
forming a second query in which the at least two terms are joined by a disjunction operator; and
the method further comprising determining a ranking order for items identified by the at least one search engine system, the determining the ranking order comprising ranking results corresponding to the first query more highly than results corresponding to the second query.

7. The method of claim 1, the information type being image input and the input information including an image, the forming the query input comprising generating text from at least a portion of the image.

8. The method of claim 7, the forming the query input further comprising substituting at least one character placeholder in the generated text in place of a portion of the image that was not successfully generated as text.

9. The method of claim 7, the forming the query input comprising matching at least one term present in the generated text with at least one search concept when the information type is image input.

10. The method of claim 7, the generated text including at least two terms, wherein:
the forming a query input comprises:
forming a first query in which the at least two terms are joined by a conjunction operator; and
forming a second query in which the at least two terms are joined by a disjunction operator; and
the method further comprising determining a ranking order for items identified by the at least one search engine system, the determining the ranking order comprising ranking results corresponding to the second query more highly than results corresponding to the first query.

11. The method of claim 1, the information type being audio input and the input information including a spoken phrase, the forming the query input comprising generating text from at least a portion of the spoken phrase.

12. The method of claim 11, the forming the query input further comprising correcting phonetic recognition errors introduced in the generated text.

13. The method of claim 11, the forming the query input comprising matching at least one term present in the generated text with at least one search concept when the information type is audio input.

14. The method of claim 11, the generated text including at least two terms, wherein:
the forming a query input comprises:
forming a first query in which the at least two terms are joined by a conjunction operator; and
forming a second query in which the at least two terms are joined by a disjunction operator; and
the method further comprising determining a ranking order for items identified by the at least one search engine system, the determining the ranking order comprising ranking results corresponding to the second query more highly than results corresponding to the first query.

15. A system for processing input information based on an information type of the input information, the system comprising:
logic for receiving input information for performing a search for identifying at least one item desired by a user;
logic for determining an information type associated with the input information;
logic for forming a query input for identifying the at least one item desired by the user based on the input information and on the information type; and
logic for submitting the query input to at least one search engine system.

16. The system of claim 15, further comprising:
logic for determining a ranking order for items identified by the at least one search engine system, the ranking order being based at least in part on the information type.

17. The system of claim 15, the logic for forming the query input comprising logic for correcting at least one of orthographic and typographic errors present in the input information when the information type is text input.

18. The system of claim 15, the logic for forming the query input comprising logic for matching at least one term present in the input information with at least one search concept when the information type is text input.

19. The system of claim 18, the logic for matching at least one term comprising logic for substituting in the query input at least one unambiguous search concept in place of the at least one term when the at least one term comprises ambiguous text input.

20. The system of claim 15, the information type being text input and the input information including at least two terms, wherein:
the logic for forming a query input comprises:
logic for forming a first query in which the at least two terms are joined by a conjunction operator; and
logic for forming a second query in which the at least two terms are joined by a disjunction operator; and
the system further comprising logic for determining a ranking order for items identified by the at least one search engine system, the determining the ranking order comprising ranking results corresponding to the first query more highly than results corresponding to the second query.

21. The system of claim 15, the information type being image input and the input information including an image, the logic for forming the query input comprising logic for generating text from at least a portion of the image.

22. The system of claim 21, the logic for forming the query input further comprising logic for substituting at least one character placeholder in the generated text in place of a portion of the image that was not successfully generated as text.

23. The system of claim 21, the logic for forming the query input comprising logic for matching at least one term present in the generated text with at least one search concept when the information type is image input.

24. The system of claim 21, the generated text including at least two terms, wherein:
the logic for forming a query input comprises:
logic for forming a first query in which the at least two terms are joined by a conjunction operator; and
logic for forming a second query in which the at least two terms are joined by a disjunction operator; and
the system further comprising logic for determining a ranking order for items identified by the at least one search engine system, the determining the ranking order comprising ranking results corresponding to the second query more highly than results corresponding to the first query.

25. The system of claim 15, the information type being audio input and the input information including a spoken phrase, the logic for forming the query input comprising logic for generating text from at least a portion of the spoken phrase.

26. The system of claim 25, the logic for forming the query input further comprising logic for correcting phonetic recognition errors introduced in the generated text.

27. The system of claim 25, the logic for forming the query input comprising logic for matching at least one term present in the generated text with at least one search concept when the information type is audio input.

28. The system of claim 25, the generated text including at least two terms, wherein:
the logic for forming a query input comprises:
logic for forming a first query in which the at least two terms are joined by a conjunction operator; and
logic for forming a second query in which the at least two terms are joined by a disjunction operator; and
the system further comprising logic for determining a ranking order for items identified by the at least one search engine system, the determining the ranking order comprising ranking results corresponding to the second query more highly than results corresponding to the first query.
